(19) United States
(12) Patent Application Publication
(10) Pub. No.: US 2003/0160699 A1
(43) Pub. Date: Aug. 28, 2003

(54) Apparatus, system and method for pest determination and notification

(75) Inventor: Mick A. Trompen, Westfield, IN (US)

Correspondence Address: PEARNE & GORDON LLP, 526 SUPERIOR AVENUE EAST, SUITE 1200, CLEVELAND, OH, 44114-1484, US

(73) Assignee: Aircom Manufacturing, Inc.

(21) Appl. No.: 10/370,784

(22) Filed: Feb. 20, 2003

Related U.S. Application Data
(60) Provisional application No. 60/359,026, filed on Feb. 22, 2002.

(51) Int. Cl. G08B 23/00

(52) U.S. Cl. 340/573.2; 43/124

(57) ABSTRACT

A pest control system, with a device and via an associated method, is used to make determination and provide notification regarding the presence of pests at a site. The pest control device of the system is located at the site. The device includes a housing, a bait member located within the housing, a sensor, located within the housing, to sense pests attracted to the bait member, and a monitoring device, located within the housing and operatively connected to the sensor, to monitor the sensor. The device also includes a communication arrangement, located within the housing and operatively connected to the monitoring device, to transmit a wireless signal indicative of the operation of the monitoring device and for reception at one or more off-site locations. The system also includes one or more communication and processing arrangements, located off-site, to receive the transmitted signal and to provide information usable to determine needed pest control.

### TECHNICAL FIELD

The present invention relates to detection of pests, such as termites, and the provision of notification with regard to the detection.

### BACKGROUND OF THE INVENTION

Subterranean termites are a particularly troublesome type of pest with the potential to cause damage to wooden structures. To prevent damage by termites, the presence of the termites must be detected and appropriate measures must be taken to eliminate the detected termites.

In one approach to the detection and elimination of termites at a site location (e.g., containing a building such as a house), a number of devices are placed in or at ground level about the site to be protected. Devices may also be placed in, on, or adjacent to the site to be protected. Each device has a termite edible material to entice termites to enter the device. Each device is inspected for the presence of termites. If the presence of termites is detected, chemically-treated bait is placed within the device. The chemically-treated bait contains a slow-acting pesticide that is intended to be carried back to a termite colony nest and that is intended to eradicate the entire termite colony.

The inspection of the devices may be performed on a routine basis. However, such routine inspection requires a large manual labor input. To reduce the amount of manual labor associated with the inspection, another approach is to utilize a passive radio communication circuit at each device. The inspection process at the site is expedited due to the use of relatively expedient interrogation procedures. Upon interrogation, each device is able to provide a signal indicative of the presence or absence of termites at the device.

### SUMMARY OF THE INVENTION

In accordance with one aspect, the present invention provides a pest control device for location at a site to be eradicated of pests. The pest control device includes a housing and a bait member located within the housing. A sensor of the device is located within the housing and senses pests attracted to the bait member. A monitoring device monitors the sensor, is located within the housing, and is operatively connected to the sensor. A communication arrangement is located within the housing and is operatively connected to the monitoring device. The communication arrangement transmits a wireless signal indicative of the operation of the monitoring device and for reception at one or more off-site locations.

In accordance with another aspect, the present invention provides a pest control system for determination and notification regarding the presence of pests at a site to be eradicated of pests. The system includes a pest control device for location at the site. The pest control device includes a housing and a bait member located within the housing. A sensor, located within the housing, senses pests attracted to the bait member. A monitoring device, located within the housing and operatively connected to the sensor, monitors the sensor. A communication arrangement, located within the housing and operatively connected to the monitoring device, transmits a wireless signal indicative of the operation of the monitoring device and for reception at one or more off-site locations. The system includes a communication and processing arrangement, located off-site, to receive the transmitted signal and to provide information usable to determine needed pest control at the site.

In accordance with yet another aspect, the present invention provides a pest control method for determination and notification regarding the presence of pests at a site to be eradicated of pests. A pest control device is provided at the site. The step of providing the pest control device includes providing the pest control device with: a housing, a bait member located within the housing, a sensor, located within the housing, to sense pests attracted to the bait member, a monitoring device, located within the housing and operatively connected to the sensor, to monitor the sensor, and a communication arrangement, located within the housing and operatively connected to the monitoring device, to transmit a wireless signal indicative of the operation of the monitoring device and for reception at one or more off-site locations. The method includes sensing pests, transmitting the wireless signal, receiving the transmitted signal at one or more communication and processing arrangements located off-site, and providing information derived from the received signal usable to determine needed pest control at the site.

In accordance with yet another aspect, the present invention provides a pest control method for determination and notification regarding the presence of pests at a site. Pests are sensed at a pest detection device located at the site. A wireless telephone signal, indicative of the sensed pests, is transmitted directly from the pest detection device. The transmitted telephone signal is received at one or more wireless telephone communication arrangements located off-site. The contents of the wireless signal are relayed as a telephone call to one or more monitoring arrangements located off-site.

### BRIEF DESCRIPTION OF THE DRAWINGS

The forgoing and other features and advantages of the present invention will become apparent to those skilled in the art to which the present invention relates upon reading the following description with reference to the accompanying drawings, wherein:

FIG. 1 is a block diagram illustration of a pest control system in accordance with the present invention;

FIG. 2 is an exploded perspective view of a pest control device utilized within the pest control system of FIG. 1;

FIG. 3 is a view similar to FIG. 2 and shows assembly of the pest control device;

FIG. 4 is a perspective view of a portion of the pest control device of FIGS. 2 and 3; and

FIG. 5 is a flow chart for a process performed in accordance with the present invention.

### DESCRIPTION OF EXAMPLE EMBODIMENTS

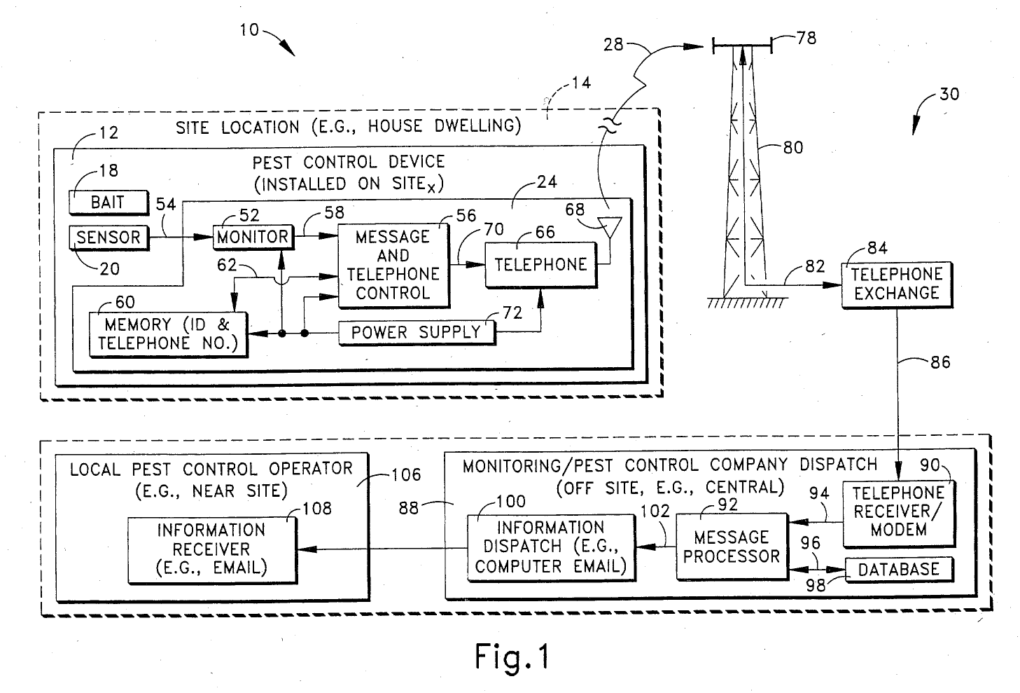

One embodiment of a pest control system 10, in accordance with the present invention, is shown in FIG. 1. The system 10 includes one or more pest control devices 12 that are present at a site location 14. The site 14 may be property that contains a building (e.g., a house dwelling).

In accordance with the present invention, it is intended that the site 14 and associated building are made to be and maintained pest free. In the example of termites, if the building contains wood, the termites may attack the wood within the building. Thus, in the case of termites, it is very desirable to eradicate the termites and maintain a termite free condition.

Turning to the pest control device 12, the device includes a bait 18 that appeals to the targeted pest. In the case of termites, the bait 18 can be wood. A sensor 20 is associated with the bait 18 for sensing whether pests are attracted to the bait. An electronics package 24 of the pest control device 12 monitors the sensor 20 and makes a determination with regard to pest activity.

The electronics package 24 is capable of transmitting a wireless signal 28 (e.g., a cellular or satellite telephone signal) for reception by a communication and processing arrangement 30. The components of the communication and processing arrangement 30 are located off-site. Specifically, all of the components within the communication and processing arrangement 30 are located at some meaningful distance from the location of the site 14. Accordingly, the components of the communication and processing arrangement 30 are not located within the building (e.g., house dwelling) nor at a location that can be considered on-site. It is to be appreciated that the communication and processing arrangement 30 may include several components for receiving the signal 28 at respective different locations. Such several, differently located components may be operatively interconnected to each other and/or to a central component. Similarly, several communication and processing arrangements 30 may be provided. Such several communication and processing arrangements 30 may be operatively interconnected to each other and/or to a central component.

The communication and processing arrangement 30 is capable of providing information usable to determine needed pest control at the site 14. Appropriate measures are taken to accomplish needed pest control. For example, a pest control technician of a pest control operator is dispatched to the site 14.

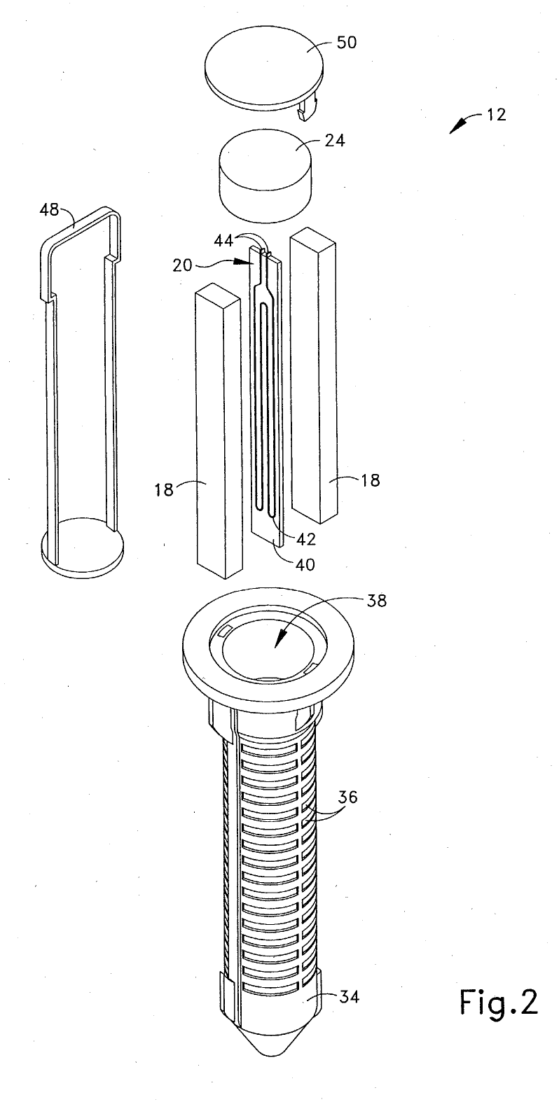

Turning to one example of the pest control device 12, attention is directed to FIG. 2. The example pest control device 12 of FIG. 2 is intended to be buried, at least partially, in soil at the site 14 (FIG. 1). The example device 12 (FIG. 2) includes a generally cylindrical housing 34. The housing 34 is elongated and hollow to provide an interior receptacle 38. A plurality of openings 36 extend through the housing 34 from the exterior of the housing to the interior receptacle 38 of the housing. Of course, it is to be appreciated that the housing 34 may have a different shape, construction, configuration, etc.

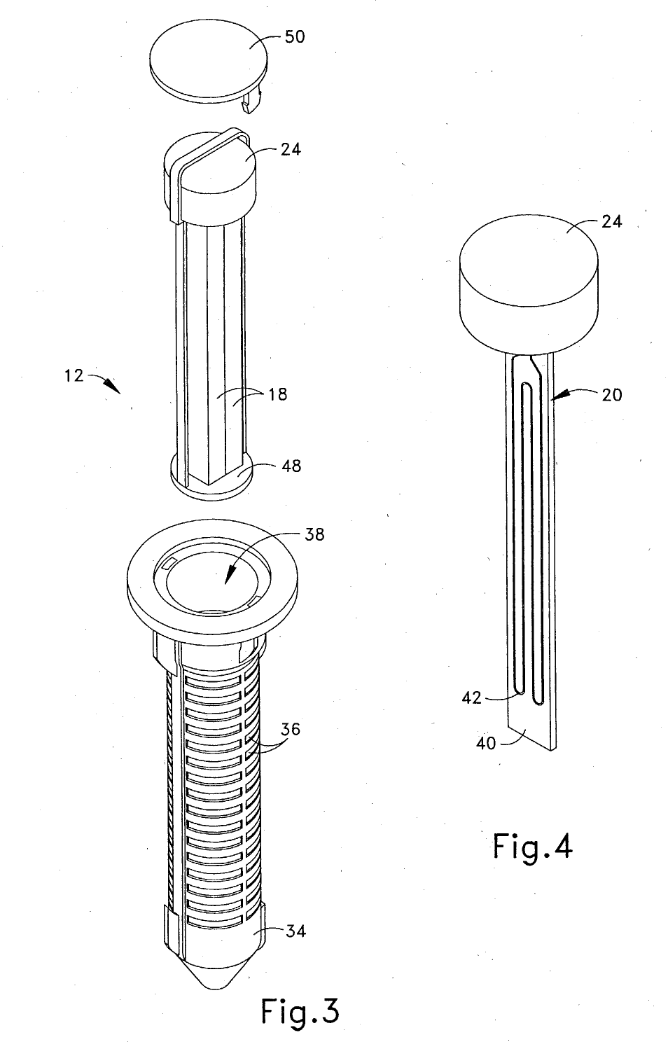

The housing 34 is intended to receive the bait 18, the sensor 20, and the electronics package 24. In the illustrated example, the bait 18 is provided as two longitudinally extending blocks of wood. The blocks of wood are shaped in size to mate with each other (see FIG. 3) and fit into the receptacle 38 of the housing 34. Of course, it is to be appreciated that the bait 18 may have a different shape, construction, configuration, etc.

The sensor 20 (FIG. 4) includes a substrate 40 that carries at least one electrically conductive pathway 42. The substrate 40, with the conductive pathway 42 located thereon, is sized for location between,the two blocks of wood that provide the bait 18 (see FIG. 2). Of course, it is to be appreciated that the sensor 20 may have a different shape, construction, configuration, etc. At an upper end of the sensor 20 are contact terminals 44 for connection of the sensor to the electronics package 24. The electronics package 24 may have any suitable shape to fit within the interior receptacle 38 of the housing 34 with the bait 18 and the sensor 20.

The pest control device 12 may include other structure and components to aid in assembly, disassembly, servicing, protection, and the like. In the illustrated example, an extractor 48 holds the bait 18, the sensor 20, and the electronics package 24 for insertion into and removal from the interior receptacle 38 of the housing 34. Also, a cap 50 mates with an upper end of the housing 34 to enclose the bait 18, the sensor 20, and the electronics package 24 within the housing.

With the components of the pest control device 12 assembled and with the pest control device installed at the site 14, the pest control device monitors for pests (e.g., termites) that are attracted to the bait 18 within the device. It is to be appreciated that the pest control device 12 may be buried in soil at the site 14 that is to be protected, or may be placed in, on, or adjacent to the site 14 that is to be protected. All such possibilities are considered to be at the site 14.

In the example, when termites locate the bait 18 within the pest control device 12, their activity will affect at least one electrical property of the sensor 20. This changed electrical property is detectable by the electronics package 24 and can be utilized to initiate the wireless signal 28 (FIG. 1) to the communication and processing arrangement 30.

Focusing for the moment on FIG. 1, details of the electronics package 24 are shown. Within the package 24, a monitor circuit 52 is operatively connected 54 (e.g., at the terminals 44, FIG. 2) to the sensor 20. A message and telephone control circuit 56 (FIG. 1) is operatively connected 58 to the monitor circuit 52. Also, a memory 60 is operatively connected 62 to the message and telephone control circuit 56.

A cellular telephone 66, with associated antenna 68, is operatively connected 70 to the message and telephone control circuit 56. It is to be appreciated that the cellular telephone 66 may be for terrestrial or satellite communication. An appropriate power supply (e.g., a battery) 72 is provided within the electronics package 24 and is connected, as necessary, to provide electrical energy to the components of the electronics package 24.

In one specific example, the cellular telephone 66 is constructed with its components printed with conductive ink on paper or synthetic polymeric sheet. Also, some or all of the other components of the electronics package 24 may be constructed with conductive ink on paper or synthetic polymeric. The various components constructed via conductive ink may be on a single sheet or may be on separate sheets. Such sheet(s) could be rolled, folded, or the like.

Also, the sensor 20 may be integrated onto a sheet with components constructed with conductive ink. Specifically, the sensor 20 and the cellular telephone 66 may be printed on the same sheet material. The sheet material may be paper, cellulose acetate film material, or the like, which is edible by termites. The portion of the sheet containing the sensor 20 would be available for consumption by the termites, but the portion containing the cellular telephone 66 would be protected (e.g., sealed within a container).

During operation, when the monitor circuit 52 detects the presence of attracted pests, the monitor circuit provides a signal to the message and telephone control circuit 56. In turn, the message and telephone control circuit 56 accesses appropriate information from the memory 60.

The memory 60 is utilized to store any pertinent information. Examples of pertinent information include an identification of the pest control device 12, and an identification of the site (e.g., house dwelling street address). The memory 60 may also hold one or more telephone numbers to be called; each telephone call provides notice concerning the presence of pests at the site location to the respective called party.

Within the message and telephone control circuit 56, a message is assembled. The message contains an indication of detected pests, an identification, etc. The telephone 66 is activated and commanded to make a cellular telephone call in response to control provided by the message and control circuit 56. Accordingly, the telephone 66 outputs the wireless signal 28 as a cellular telephone call.

The wireless signal (e.g., the cellular telephone call) 28 is received at a cellular antenna array 78 mounted on a remotely located cellular tower 80. The antenna array 78 is operatively connected 82 to a telephone exchange 84. The telephone exchange 84 contains any number of components, locations, transmission/reception devices, etc. The cellular antenna array 78 and the telephone exchange 84 are a first leg of the communication and processing arrangement 30. Specifically, the first leg of the communication and processing arrangement 30 receives the transmitted signal 28 and conveys the information contained therein. Of course, if the communication is via satellite, the communication and processing arrangement 30 has suitable components (e.g., satellite and down-link components).

The telephone exchange 84 processes the incoming cellular telephone call and conveys 86 the telephone call along to a monitoring/pest control company dispatch location 88. In the illustrated example, the monitoring and dispatch location 88 includes a telephone receiver/modem 90. A message processor 92 is operatively connected 94 to the telephone receiver/modem 90. The message processor 92 is operatively connected 96 to a database storage device 98.

It is to be appreciated that if the communication and processing arrangement 30 has several components for receiving the signal 28 at respective different locations or if several communication and processing arrangements 30 are provided. Some components, such as the database device 98, may be operatively interconnected and shared. As another possibility, some components, such as the database device 98, may located at central location to access by several monitoring/pest control company dispatch locations 88.

Information stored within the database includes identification information regarding the pest control devices that are actively being monitored, information about site locations, information about local pest control operators, and other useful information. When the message processor 92 receives the information contained within the transmitted signal 28 and conveyed to the monitoring and dispatch location 88, the message processor accesses and matches information from the database device 98.

An information dispatch component 100 is operatively connected 102 to the message processor 92. The information dispatch component 100 accepts the matched database and transmitted information from the message processor 92 and generates a message intended for reception by a pest control operator 106. In one example, the information is dispatched to the pest control operator in the form of a computer email, a voice mail, or other form of messaging that is received at an information receiver 108. It should be noted that the pest control operator 106 may or may not be at the same physical location as the monitoring and dispatch location 88. The possibility of the pest control operator 106 and the monitoring and dispatch location 88 being at the same location is indicated by the dash line in FIG. 1.

It is to be appreciated that the dispatch location and the location of the pest control operator are considered off-site. It is only when the local operator receives a message indicating need for attention at a site location does the pest control operator travel to the site location.

It is to be noted that the pest control operator 106 may then undertake any appropriate pest control measure. Typically, the operator will replace the wood bait 18 of the pest control device 12 with a chemically treated paper. Also, any termites that are physically with the pest control device 12 at the time of replacement are then placed back within the housing 34 at a location that forces the termites to eat through the chemically treated paper to return to their termite colony. The termites continue to return to the pest control device 12, with the chemically treated paper, because the location has been identified as food source by the termites.

The chemical used to treat the paper is a chitin inhibitor, which prevents the termites from molting. The chemical is slow acting, but can eventually eliminate an entire colony. It should be appreciated that other forms of treatment can be utilized.

In one example, it is contemplated that the pest control device 12 transmits the wireless signal 28 when pests are detected. However, it is also contemplated that other communication between the pest control device 12 and the communication and processing arrangement 30 is possible. For example, the pest control device 12 could periodically transmit a signal to the communication and processing arrangement 30 indicating that the pest control device is operational. Alternatively, the communication and processing arrangement 30 could transmit a query signal to the pest control device 12 as a prompt for the pest control device to transmit a signal indicating that the pest control device is operational.

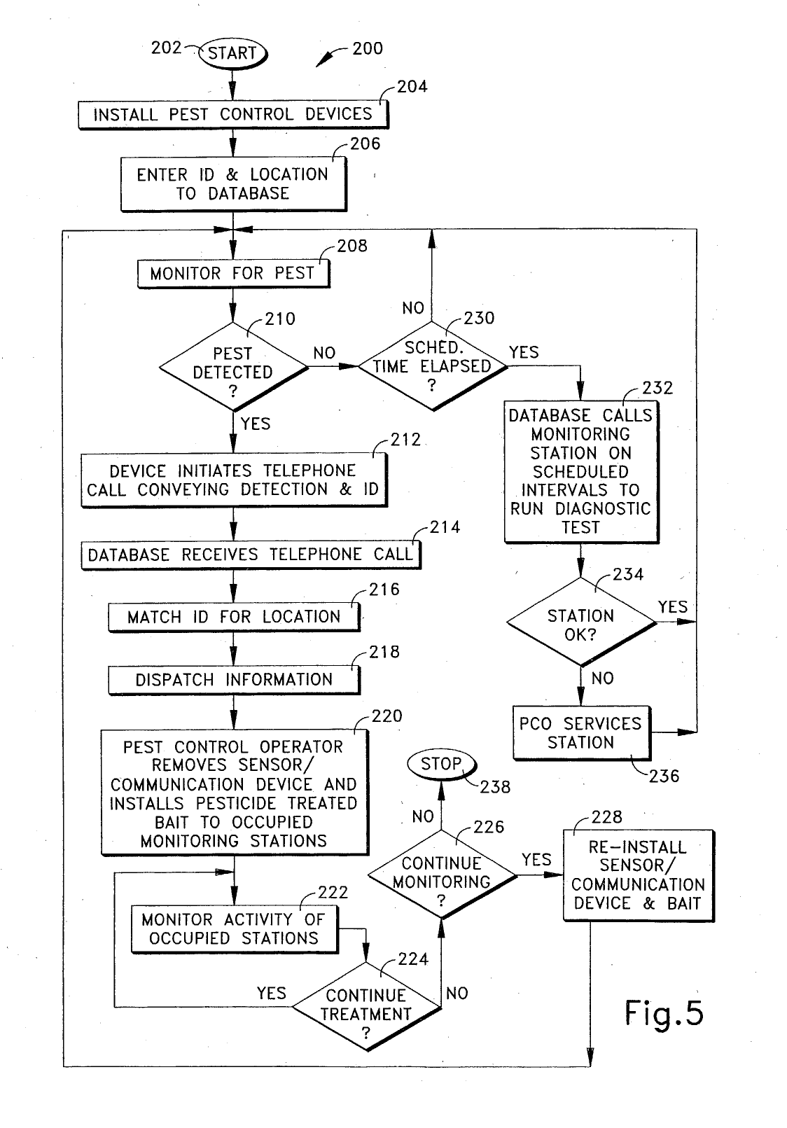

FIG. 5 illustrates an example of a process 200 in accordance with the present invention. The process 200 is initiated at step 202 and proceeds to step 204. At step 204, one or more pest control devices 12 are installed (i.e., put in place at the site 14). Typically, several pest control devices 12 are located about a periphery of a house dwelling or the like. At step 206, identification and location information are entered into the database device 98 at the monitoring and dispatch location 88.

At step 208, within the pest control device 12, the sensor 20 is monitored to determine whether pests have been attracted to the bait 18. At step 210, it is determined whether pests have been detected. If the determination at step 210 is affirmative (i.e., pests are detected) the process 200 goes to step 212. At step 212, the pest control device 12 provides the wireless signal, which is the cellular telephone call, conveying the information regarding detection and device identification.

At step 214, the cellular telephone call is received. At step 216, information provided via the telephone call is matched with information from the database device 98 and location of the site is determined. The information is dispatched for use by the local pest control operator 106 at step 218.

At step 220, the pest control operator 106 is on site 14. The bait 18, the sensor 20 and the electronics package 24 are removed and replaced with a pesticide bait at the identified pest control device 12. Such replacement may be performed at more that one pest control device 12 at the site 14. Specifically, other pest control devices 12 at the site location may be inspected to see if pests are present, and replacement with pesticide bait is done as deemed necessary. At step 222, activity at the pest control device(s) 12 is monitored during the time period that the pesticide bait is present. Specifically, the pest control device(s) 12 are monitored to determine use, consumption, etc. of the pesticide bait by the pests. At step 224, it is determined whether to continue with the treatment (i.e., provision of pesticide bait) at the pest control devices 12. Such a determination is dependent upon monitored success, etc. at the site location.

If the determination at step 224 is affirmative (e.g., the provision of pesticide bait is to be continued), the process 200 goes from step 224 to step 222. It is noted that the pesticide bait may be replenished at the pest control device 12.

If the determination at step 224 is negative (i.e., the treatment is to be discontinued) the process 200 goes to step 226. At step 226 it is determined if remote monitoring of the site for pests is to continue. If the determination at step 226 is affirmative (i.e., the remote monitoring is to be continued), then the process 200 goes to step 228.

At step 228, the pesticide bait is removed from the pest control device 12 and is replaced with the sensor 20 and the electronics package 24. The process 200 loops from step 228 to step 208 to again monitor for pests.

If, as a result of the monitoring (step 208) and the detection (step 210) pests are not detected, then the determination at step 210 is negative. Upon the negative determination at step 210, the process 200 goes to step 230. At step 230, it is determined if a pre-scheduled time for reporting operability to the monitoring and dispatch location 88 has elapsed. If the pre-scheduled time period for reporting has not yet elapsed (i.e., the determination at step 230 is negative), then the process 200 loops to step 208. As such, the process typically repeatedly loops through steps 208, 210, and 230.

If the pre-scheduled time period for reporting has elapsed (i.e., the determination at step 230 is affirmative), then the process 200 goes to step 232. At step 232, communication regarding the operability of the pest control device 12 occurs. This communication initiates and provides for the conveyance of diagnostic information from the pest control device 12. As mentioned, the communication can be at scheduled intervals. Also, the communication can be initiated by the database-containing monitoring and dispatch location 88.

At step 234 it is determined in the pest control device or station 12 is functioning properly. If the determination at step 234 is affirmative (i.e., the pest control device 12 is functioning properly), then the process 200 loops to step 208 for further monitoring. If the determination at step 234 is negative (i.e., the pest control device is not functioning properly), then the process 200 goes to step 236, in which PCO service is performed.

It is contemplated that the pest control device 12 will remain in place for some time. During such time, monitoring (i.e., steps 208 and 210) will of course occur. Also, pest detection and remote communication (i.e., steps 212-218) and pest control (i.e., steps 220-228) could occur. Still further, the diagnostic and possible correction (i.e., steps 230-236) could occur. If, after the pest control device 12 is no longer needed (e.g., the pests are eradicated), the process 200 goes to step 238 and the device is removed.

From the above description of the invention, those skilled in the art will perceive improvements, changes and modifications. Such improvements, changes and modifications within the skill the of the art are intended to be covered by the appended claims.

The following is claimed:

1. A pest control device for location at a site to be eradicated of pests, the pest control device including:
a housing;
a bait member located within the housing;
a sensor, located within the housing, to sense pests attracted to the bait member;
a monitoring device, located within the housing and operatively connected to the sensor, to monitor the sensor; and
a communication arrangement, located within the housing and operatively connected to the monitoring device, to transmit a wireless signal indicative of the operation of the monitoring device and for reception at one or more off-site locations.

2. The pest control device as set forth in claim 1, wherein the communication arrangement includes a cellular telephone to transmit a wireless telephone call as the wireless signal.

3. The pest control device as set forth in claim 2, wherein the wireless telephone is a low-cost telephone.

4. The pest control device as set forth in claim 2, wherein the wireless telephone is constructed to have paper or synthetic polymeric components printed with conductive ink.

5. The pest control device as set forth in claim 1, wherein the monitoring device controls the communication arrangement to transmit the wireless signal when pests are sensed.

6. A pest control system for determination and notification regarding the presence of pests at a site to be eradicated of pests, the system including:
a pest control device for location at the site, the pest control device including:
(a) a housing;
(b) a bait member located within the housing;
(c) a sensor, located within the housing, to sense pests attracted to the bait member;
(d) a monitoring device, located within the housing and operatively connected to the sensor, to monitor the sensor; and
(e) a communication arrangement, located within the housing and operatively connected to the monitoring device, to transmit a wireless signal indicative of the operation of the monitoring device and for reception at one or more off-site locations; and
a communication and processing arrangement, located off-site, to receive the transmitted signal and to provide information usable to determine needed pest control at the site.

7. The pest control system as set forth in claim 6, wherein the communication arrangement includes a cellular telephone to transmit a wireless telephone call as the wireless signal.

8. The pest control system as set forth in claim 7, wherein the wireless telephone is a low-cost telephone.

9. The pest control system as set forth in claim 7, wherein the wireless telephone is constructed to have paper or synthetic polymeric components printed with conductive ink.

10. The pest control system as set forth in claim 6, wherein the monitoring device controls the communication arrangement to transmit the wireless signal when pests are sensed.

11. The pest control system as set forth in claim 6, wherein the off-site communication and processing arrangement includes a wireless telephone signal reception arrangement to receive the transmitted signal and to convey the contents of the transmitted signal as a telephone signal, and a monitoring arrangement for receiving the telephone signal and processing the information contained therein.

12. A pest control method for determination and notification regarding the presence of pests at a site to be eradicated of pests, the method including:
providing a pest control device at the site, the step of providing the pest control device including providing the pest control device with:
(a) a housing;
(b) a bait member located within the housing;
(c) a sensor, located within the housing, to sense pests attracted to the bait member;
(d) a monitoring device, located within the housing and operatively connected to the sensor, to monitor the sensor; and
(e) a communication arrangement, located within the housing and operatively connected to the monitoring device, to transmit a wireless signal indicative of the operation of the monitoring device and for reception at one or more off-site locations;
sensing pests;
transmitting the wireless signal;
receiving the transmitted signal at one or more communication and processing arrangements located off-site; and
providing information derived from the received signal usable to determine needed pest control at the site.

13. A pest control method for determination and notification regarding the presence of pests at a site, the method including:
sensing pests at a pest detection device located at the site;
transmitting a wireless telephone signal, indicative of the sensed pests, directly from the pest detection device;
receiving the transmitted telephone signal at one or more wireless telephone communication arrangements located off-site; and
relaying the contents of the wireless signal as a telephone call to one or more monitoring arrangements located off-site.
